(19) United States
(12) Patent Application Publication
(10) Pub. No.: US 2004/0236729 A1
(43) Pub. Date: Nov. 25, 2004

(54) Systems and methods for clustering objects from text documents and for identifying functional descriptors for each cluster

(76) Inventors: Raymond Dingledine, Atlanta, GA (US); Brian James Ciliax, Decatur, GA (US); Ashwin Ram, Atlanta, GA (US); Shamkant B. Navathe, Alpharetta, GA (US); James Brian Revennaugh, Kennesaw, GA (US); Jorge Civera Saiz, Valencia (ES); Ying Liu, Atlanta, GA (US)

Correspondence Address: THOMAS, KAYDEN, HORSTEMEYER & RISLEY, LLP, 100 GALLERIA PARKWAY, NW, STE 1750, ATLANTA, GA, 30339-5948, US

(21) Appl. No.: 10/761,776

(22) Filed: Jan. 21, 2004

Related U.S. Application Data
(60) Provisional application No. 60/441,850, filed on Jan. 21, 2003.

(51) Int. Cl. G06F 7/00

(52) U.S. Cl. 707/3

(57) ABSTRACT

Systems and methods for organizing and aiding the interpretation of large amounts of data are disclosed. One embodiment of the system, among others, includes receiving gene names, associating the gene names to gene-word pair relationships, and grouping the gene names with high strength of gene-word relationships, the strength of the gene-word relationships corresponding to the relatedness in function of corresponding grouped genes.

### CROSS REFERENCE TO RELATED APPLICATION

This application claims the benefit of U.S. Provisional Application No. 60/441,850, filed Jan. 21, 2003, which is entirely incorporated herein by reference.

### FIELD OF THE INVENTION

The present disclosure is generally related to informatics tools, and more particularly related to text identification tools.

### BACKGROUND OF THE INVENTION

The development of high density microarrays of cDNAs or oligonucleotides in the late 1990's has brought a new level of sensitivity and specificity to large-scale monitoring of gene expression. In a typical DNA microarray exploratory experiment, the expression of tens of thousands of candidate genes are monitored in disease or drug-treated tissue simultaneously, with the hope of discovering a pattern of gene expression involved in the regulation of the biological process under study, and ultimately of identifying novel proteins that may become new drug targets. The use of exploratory DNA microarrays is widely expected to enable the identification of many new drug targets in pharmaceutical drug development programs, but substantial impediments have slowed this effort.

Since technology for massively parallel gene expression monitoring was introduced three years ago, many methods have been developed for initial statistical analysis of the numerical expression profiles, but investigators in academic and pharmaceutical laboratories alike have been greatly challenged to achieve valuable biological insights from the resulting voluminous data. Methods for interpreting microarray data lag far behind the technology for generating the primary data. As costs for the technology decline, microarray experiments will be used in increasingly more laboratories, both industrial and academic. Furthermore, the number of identified genes is expected to increase; consequently, the number of genes represented on microarrays is expected to increase. Soon, the entire collection of genes from the human genome will become available on gene chips. Thus, a need exists in the industry to address the aforementioned and/or other deficiencies and/or inadequacies.

### SUMMARY

Embodiments of the present disclosure include systems and methods for organizing and aiding the interpretation of large amounts of data. One embodiment of the system, among others, includes receiving gene names, associating the gene names to gene-word pair relationships, and grouping the gene names with high strength of gene-word relationships, the strength of the gene-word relationships corresponding to the relatedness in function of corresponding grouped genes.

Other systems, methods, features, and advantages of the present disclosure will be or become apparent to one with skill in the art upon examination of the following drawings and detailed description. It is intended that all such additional systems, methods, features, and advantages be included within this description, be within the scope of the present disclosure, and be protected by the accompanying claims.

### BRIEF DESCRIPTION OF THE DRAWINGS

Embodiments of the disclosure can be better understood with reference to the following drawings. The components in the drawings are not necessarily drawn to scale, emphasis instead being placed upon clearly illustrating the principles of the present disclosure. In the drawings, like reference numerals designate corresponding parts throughout the several views.

FIG. 1 is a block diagram depicting an example system environment in which a function cluster system can reside, in accordance with one embodiment of this disclosure.

FIG. 2 is a block diagram depicting an example network infrastructure for implementing the function cluster system shown in FIG. 1, in accordance with one embodiment of this disclosure.

FIG. 3 is a block diagram depicting an example computer system in which the function cluster system described in association with FIG. 1 can reside, in accordance with one embodiment of this disclosure.

FIGS. 4A and 4B are flow diagrams depicting an example cluster method of the function cluster system, in accordance with one embodiment of this disclosure.

FIG. 5 is a flow diagram depicting another example cluster method, in accordance with one embodiment of this disclosure.

FIG. 6 is a schematic diagram depicting an example user interface, in accordance with one embodiment of this disclosure.

### DETAILED DESCRIPTION OF THE PREFERRED EMBODIMENTS

The present disclosure now will be described more fully hereinafter with reference to the accompanying drawings, in which preferred embodiments of this disclosure are shown. The preferred embodiments of this disclosure will herein be described in the context of a system and method that are used to assist in the interpretation of DNA microarray data. In particular, the preferred embodiments of this disclosure include a system and method for organizing genes according to function, enabling investigators to more quickly discover patterns and/or themes of biological processes that were revealed by their microarray experiments and focus on a select group of functionally related genes. This system, herein referred to as a function cluster system, includes methodology that aids researchers in data analysis and hypothesis development by intelligently merging large amounts of data generated by DNA microarray and other modern experimentation techniques with one or more public and/or proprietary biomedical literature databases, such as, for example, MEDLINE, among others.

In one embodiment, the function cluster system accepts an unordered list of objects (e.g., protein or gene names) and returns those objects clustered by their underlying common features, as preferably reflected in a text database appropriate to the nature of the clustered objects. The program additionally returns a list of keywords that describes the common function of each cluster. The function cluster system includes algorithms that have been developed and optimized for acting on gene and protein names derived from microarray experiments.

As a guide to the description that follows, an overview will be presented with the aid of a block diagram illustrating the general features of the function cluster system and cooperating elements. Following the overview are some example infrastructures in which the function cluster system can be implemented, followed by some example flow diagrams that are used to illustrate two example methods the function cluster system implements to provide an output in accordance with the preferred embodiments. An example graphics user interface (GUI) is also presented. Finally, an example implementation is presented to provide further illustration of the function cluster system.

The function cluster system may, however, be embodied in many different forms and should not be construed as limited to the embodiments, examples and implementations set forth herein. For example, the “objects” used as input to the function cluster system can include individual conversations, brain regions, or drug names, among others. In particular, the method of linking text to functional entities can be extended to other fields entirely, if the background sets of words are adjusted appropriately. For example, rather than link keywords to genes, modified algorithms could link adverse effects to drugs, or keywords to human diseases. Further, the function cluster system can be extended to other domains, such as developing tools for diagnostics and therapy in diseases.

Another potential use of the function cluster system is in the field of intelligence. The National Security Association (NSA) routinely monitors verbal and electronic communications from a large number of people, organizations, and countries. One of their objectives is simply to monitor the frequency of communications, because spikes in conversation frequency (the “chatter rate”) typically precede terrorist actions or other large-scale adverse events. This is a rudimentary use of the monitoring. The function cluster system would treat all words in every monitored translated conversation over a period of time (e.g., one day) as a background set, and the conversations of a) individuals, b) organizations, or c) countries as query sets (as explained further below). In accordance with the preferred embodiments, the function cluster system can then be used to identify clusters of individuals or groups who are all discussing a similar topic (e.g., terrorist targets).

In another implementation, the function cluster system could also be extended to associate functional keywords with brain regions and used as an overlay to a “brain atlas”. For example, when a user clicks on a brain region, the name of the region appears in a display screen window, along with a list of functionally relevant keywords that inform the user about potential functions of that brain region. Control-clicking multiple brain regions is treated as a cluster and any keywords representative of shared functions are displayed.

Further, the function cluster system could be modified to cluster additional objects (e.g., diseases, risk factors, etc.) along with the genes.

Also, some embodiments of the function cluster system can be implemented in a manner that extracts multi-word phrases. For example, “dopamine D1 receptor” could refer to a specific biological entity instead of just single words. In other words, “dopamine D1 receptor” in one embodiment can be broken down into the individual words of dopamine, D1, and receptor. Dopamine is a neurotransmitter that interacts with other receptors. D1 could be a dopamine receptor, but can also be the phospholipase D1 enzyme, the small nuclear ribonucleoprotein D1, cyclin D1 , etc. A receptor can refer to any of a number of hormonal or neurotransmitter, second messenger receptors. Thus, in some implementations, the use of the entire phrase may provide more specificity than the extraction of single words. In still other embodiments, a combinational approach of using words and phrases may be implemented.

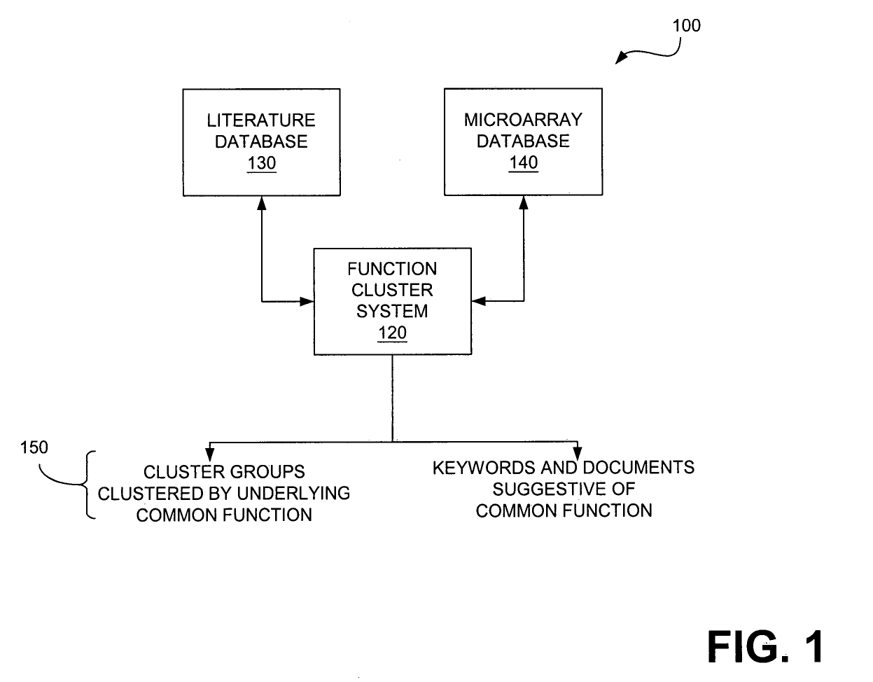

FIG. 1 is a block diagram depicting an example system environment 100 in which a function cluster system 120 can reside, in accordance with one embodiment. The example system environment 100 includes a literature database 130, a microarray database 140, and the function cluster system 120, which provides an output 150 that includes one or more cluster groups that are grouped (or clustered) by underlying common function. The output 150 also includes keywords and/or documents that are suggestive of each underlying common function. The literature database 130 preferably includes biomedical literature, such as abstracts, that include information about genes and/or proteins that are to be searched by the function cluster system 120. In some embodiments, the literature database 130 can include one or more popular biomedical databases such as MEDLINE, GenBank, and/or SwissProt that are licensed for use, or other public and/or proprietary databases, such as Society for Neuroscience Abstracts. The information retrieved from the literature database 130 by the function cluster system 120 is preferably up-to-date and unbiased in the sense that it reflects information from all biomedical science rather than that from a single or a few human curator(s), although the scope of this disclosure can include the latter mechanisms as well.

The microrarray database 140 preferably includes information in the form of an expression of genes and/or proteins from exploratory experimentation of disease or drug-treated tissue, among other sources. This information can be entered into the function cluster system 120 in an automated fashion (e.g., download or transfer of spreadsheet information, either responsive to a request by the function cluster system 120, automatically input, or otherwise), and/or manually inputted. The function cluster system 120 preferably retrieves the information of the literature database 130 and receives information from the experimental microarray database 140 and processes this information in an effort to provide an output 150 that groups large numbers of genes and/or proteins into functionally-relevant clusters and suggests the common functions of each cluster. In other words, the function cluster system 120 generates discrete gene and/or protein clusters from functional information and provides a mechanism by which the common function of gene and/or protein clusters can be inferred. Thus, the function cluster system 120 aids in the interpretation of the high volume of data produced by microarray experiments.

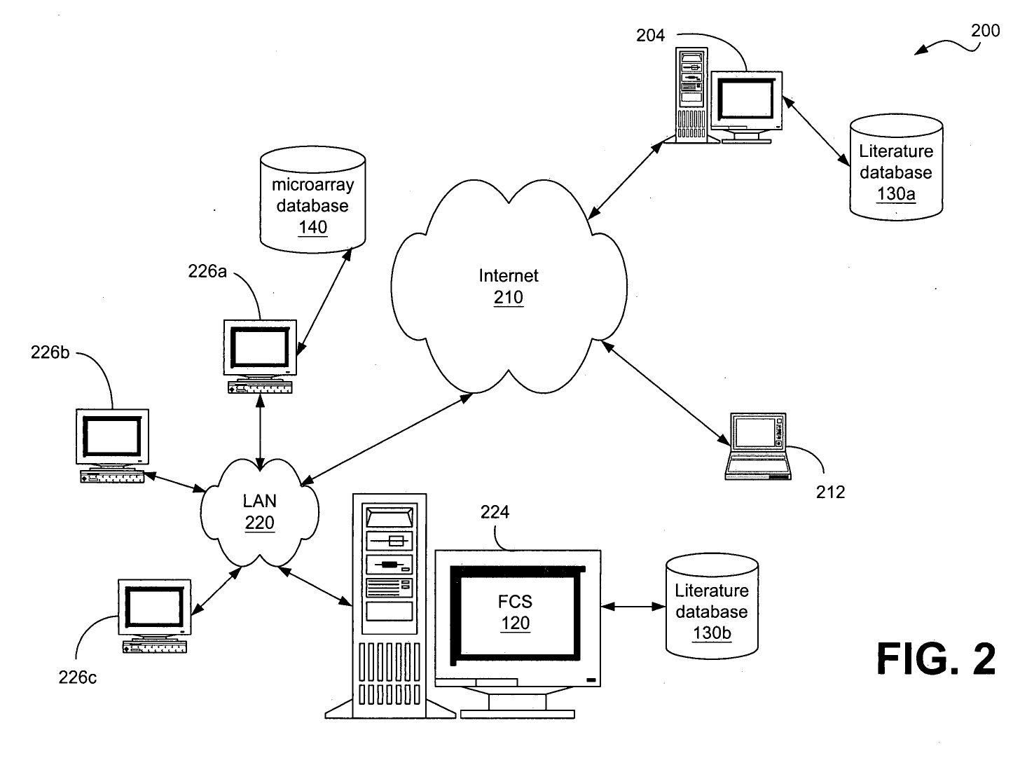

FIG. 2 is a block diagram depicting an example network infrastructure 200 for implementing the function cluster system 120 shown in FIG. 1, in accordance with one embodiment. The example network infrastructure 200 includes one or more local area networks (LANs) 220 that support a plurality of workstations 226a-c, which are served by one or more LAN servers 224 that have one or more accompanying literature databases 130b internal or external to the LAN server 224. The LAN 220 is coupled to the Internet 210, with or without an intermediary Internet service provider (not shown), as is true for other components shown. As is well known to those skilled in the art, the Internet 210 is coupled to a host of other networks (e.g., LANs, wide area networks, regional area networks, etc.) and users, such as to a user associated with laptop 212. A central server 204 includes, or is in communication with, one or more associated central literature databases 130a, and is also coupled to the Internet 210, among other networks not shown.

In one embodiment, a central literature database 130a can be maintained and updated, and licensed out for use by one or more users or facilities, such as a corporate or institutional research facility. Access to the central literature database 130a can be implemented over the Internet 210, or in other embodiments, a local copy can be maintained at the LAN database 130b. In the latter embodiment, the LAN server 224 can support the workstations 226a-c, which, for example, receive the microarray data from a microarray database 140, by embodying the function cluster system 120 as one or more modules of application software. The microarray data can also be input and maintained at a more central location, such as at the LAN server 224, for example, and distributed to the workstations 226a-c over the LAN 220. One skilled in the art will understand that a plurality of implementation schemes can be used, such as running function cluster system software at user sites (e.g., at laptop computer 212) and/or at the individual workstations 226a-c. One skilled in the art will also understand that the various databases, such as the literature database 230b, can be stored on a digital video disc (DVD) or other storage medium, run from the workstations 226a-c, network server 224, laptop 212, etc., and updated periodically or otherwise via the central server 204. Further, one skilled in the art would understand that communication among the various components in the example network infrastructure 200 can be provided using one or more of a plurality of transmission mediums (e.g., Ethernet, T1, hybrid fiber/coax, etc.) and protocols (e.g., via HTTP and/or FTP, etc.).

In some embodiments, the entire data of one or more literature databases can be partitioned on multiple machines and processed in parallel. For example, the various components cooperating with the function cluster system 120 can be implemented as a distributed architecture in which each machine will have its own portion of a literature database 130b in order to process the same query on multiple machines simultaneously and compile the results by using a distributed implementation of the function cluster system 120.

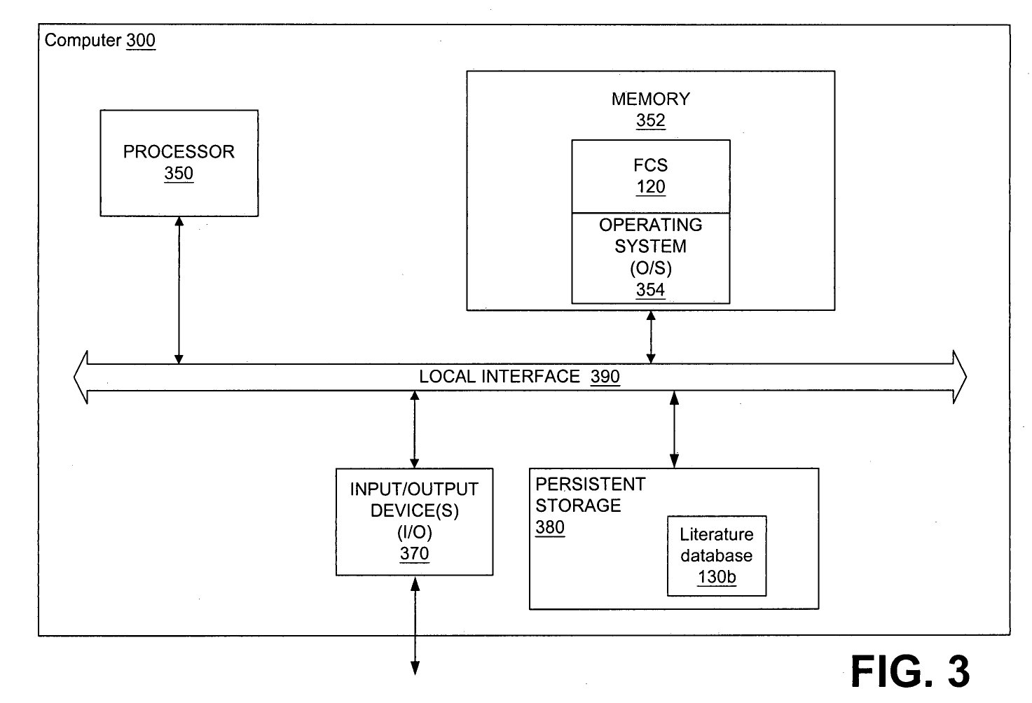

FIG. 3 is a block diagram of an example general purpose computer 300 that can implement the function cluster system 120, in accordance with one embodiment. With continued reference to FIG. 2, one skilled in the art will understand that the example general purpose computer 300 can be embodied as the network server 224, workstations 226a-c, laptop 212, and/or central server 204 of the example network infrastructure 200, alone or in combination (i.e., in a single component, or distributed over several components in the example network infrastructure 200), among other embodiments. Further, one skilled in the art will understand that additional components or different components with similar functionality can be included in the general purpose computer 300, and/or some components can be omitted, in other embodiments. The function cluster system (FCS) 120 can be implemented in software (e.g., firmware), hardware, or a combination thereof. In the currently contemplated best mode, the function cluster system 120 is implemented in software, as an executable program, and is executed by a special or general purpose digital computer, such as a personal computer (PC; IBM-compatible, Apple-compatible, or otherwise), workstation, minicomputer, or mainframe computer.

Generally, in terms of hardware architecture, as shown in FIG. 3, the general purpose computer 300 includes a processor 350, memory 352, persistent storage (e.g., DVD, CD, etc.) 380, and one or more input and/or output (I/O) devices 370 (or peripherals) that are communicatively coupled via a local interface 390. The local interface 390 can be, for example but not limited to, one or more buses or other wired or wireless connections, as is known in the art. The local interface 390 may have additional elements, which are omitted for simplicity, such as controllers, buffers (caches), drivers, repeaters, and receivers, to enable communications. Further, the local interface 390 may include address, control, and/or data connections to enable appropriate communications among the aforementioned components.

The processor 350 is a hardware device capable of executing software, particularly that stored in memory 352. The processor 350 can be any custom made or commercially available processor, a central processing unit (CPU), an auxiliary processor among several processors associated with the computer 300, a semiconductor based microprocessor (in the form of a microchip or chip set), a macroprocessor, or generally any device for executing software instructions. Examples of suitable commercially available microprocessors are as follows: a PA-RISC series microprocessor from Hewlett-Packard Company, an 80×86 or Pentium series microprocessor from Intel Corporation, a PowerPC microprocessor from IBM, a Sparc microprocessor from Sun Microsystems, Inc, or a 68xxx series microprocessor from Motorola Corporation.

The memory 352 can include any one or combination of volatile memory elements (e.g., random access memory (RAM, such as DRAM, SRAM, SDRAM, etc.)) and nonvolatile memory elements (e.g., ROM, hard drive, tape, CDROM, etc.). Moreover, the memory 352 may incorporate electronic, magnetic, optical, and/or other types of storage media. Note that the memory 352 can have a distributed architecture, where various components are situated remote from one another, but can be accessed by the processor 350.

The software in memory 352 may include one or more separate programs, each of which comprises an ordered listing of executable instructions for implementing logical functions. In the example of FIG. 3, the software in the memory 352 includes the function cluster system 120 in accordance with the present invention and a suitable operating system (O/S) 354. A nonexhaustive list of examples of suitable commercially available operating systems 354 is as follows: (a) a Windows operating system available from Microsoft Corporation; (b) a Netware operating system available from Novell, Inc.; (c) a Macintosh operating system available from Apple Computer, Inc.; (e) a UNIX operating system, which is available for purchase from many vendors, such as the Hewlett-Packard Company, Sun Microsystems, Inc., and AT&T Corporation; (d) a LINUX operating system, which is freeware that is readily available on the Internet; (e) a run time Vxworks operating system from WindRiver Systems, Inc.; or (f) an appliance-based operating system, such as that implemented in handheld computers or personal data assistants (PDAs) (e.g., PalmOS available from Palm Computing, Inc., and Windows CE available from Microsoft Corporation). The operating system 354 essentially controls the execution of other computer programs, such as the function cluster system 120, and provides scheduling, input-output control, file and data management, memory management, and communication control and related services.

The function cluster system 120 is a source program, executable program (object code), script, and/or any other entity comprising a set of instructions to be performed. When a source program, then the program needs to be translated via a compiler, assembler, interpreter, or the like, which may or may not be included within the memory 352, so as to operate properly in connection with the O/S 354. Furthermore, the function cluster system 120 can be written as (a) an object oriented programming language, which has classes of data and methods, or (b) a procedure programming language, which has routines, subroutines, and/or functions, for example but not limited to, C, C++, Pascal, Basic, Fortran, Cobol, Perl, Java, and Ada. In the currently contemplated best mode of practicing the invention, the function cluster system 120 is software.

The I/O devices 370 may include input devices, for example but not limited to, a keyboard, mouse, scanner, microphone, etc. For example, microarray data from the microarray database 140 (FIG. 1) may be input via a keyboard input, transferred, transmitted, and/or downloaded. Furthermore, the I/O devices 370 may also include output devices, for example but not limited to, a printer, display, etc. Finally, the I/O devices 370 may further include devices that communicate both inputs and outputs, for instance but not limited to, a modulator/demodulator (modem; for accessing another device, system, or network), a radio frequency (RF) or other transceiver, a telephonic interface, a bridge, a router, etc.

If the computer 300 is a PC, workstation, or the like, the software in the memory 352 may further include a basic input output system (BIOS) (omitted for simplicity). The BIOS is a set of essential software routines that initialize and test hardware at startup, start the O/S 354, and support the transfer of data among the hardware devices. The BIOS is stored in ROM so that the BIOS can be executed when the computer 300 is activated.

The persistent storage 380 includes an optical storage device or a magnetic storage device, among others, and is preferably a DVD. The persistent storage 380 can be used to store all or part of the literature database 130 (FIG. 1) downloaded or otherwise copied and/or transferred from a source literature database, such as from a licensor. Thus, in one implementation, a literature database 130b (i.e., a copy of the original) is located in persistent storage 380, and updated periodically, as agreed, and/or as requested, via an administrator (or otherwise) requesting the same over a network communication enabled through the I/O device 370.

When the computer 300 is in operation, the processor 350 is configured to execute software stored within the memory 352, to communicate data to and from the memory 352, and to generally control operations of the computer 300 pursuant to the software. The function cluster system 120 and the O/S 354, in whole or in part, but typically the latter, are read by the processor 350, perhaps buffered within the processor 350, and then executed.

In some embodiments, the function cluster system software can be parallelized using appropriate tools for parallelization of code and run on parallel processors. In one implementation, parallel algorithms can be used for the “off-line” work of creating the keyword-gene databases as well as developing the hyperlinked structures of related words.

When the function cluster system 120 is implemented in software, as is shown in FIG. 3, it should be noted that the function cluster system 120 can be stored on any computer readable medium for use by or in connection with any computer related system or method. In the context of this document, a computer readable medium is an electronic, magnetic, optical, or other physical device or means that can contain or store a computer program for use by or in connection with a computer related system or method. The function cluster system 120 can be embodied in any computer-readable medium for use by or in connection with an instruction execution system, apparatus, or device, such as a computer-based system, processor-containing system, or other system that can fetch the instructions from the instruction execution system, apparatus, or device and execute the instructions. In the context of this document, a “computer-readable medium” can be any means that can store, communicate, propagate, or transport the program for use by or in connection with the instruction execution system, apparatus, or device. The computer readable medium can be, for example but not limited to, an electronic, magnetic, optical, electromagnetic, infrared, or semiconductor system, apparatus, device, or propagation medium. More specific examples (a nonexhaustive list) of the computer-readable medium would include the following: an electrical connection (electronic) having one or more wires, a portable computer diskette (magnetic), a random access memory (RAM) (electronic), a read-only memory (ROM) (electronic), an erasable programmable read-only memory (EPROM, EEPROM, or Flash memory) (electronic), an optical fiber (optical), and a portable compact disc read-only memory (CDROM) (optical). Note that the computer-readable medium could even be paper or another suitable medium upon which the program is printed, as the program can be electronically captured, via for instance optical scanning of the paper or other medium, then compiled, interpreted or otherwise processed in a suitable manner if necessary, and then stored in a computer memory.

In an alternative embodiment, where the function cluster system 120 is implemented in hardware, the function cluster system 120 can implemented with any or a combination of the following technologies, which are each well known in the art: a discrete logic circuit(s) having logic gates for implementing logic functions upon data signals, an application specific integrated circuit (ASIC) having appropriate combinational logic gates, a programmable gate array(s) (PGA), a field programmable gate array (FPGA), etc.

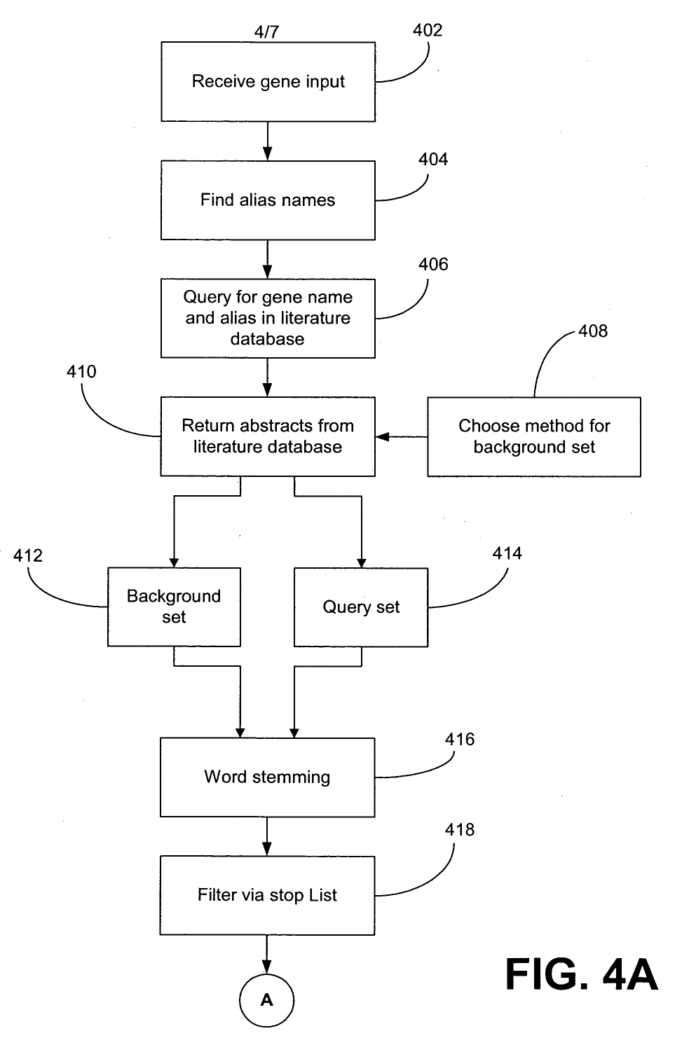

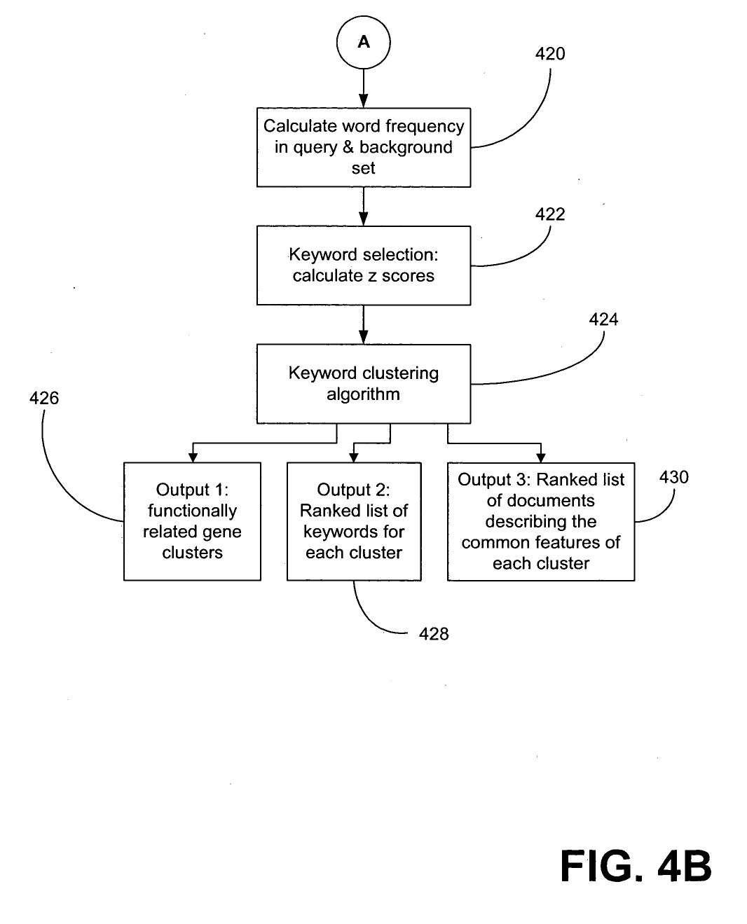

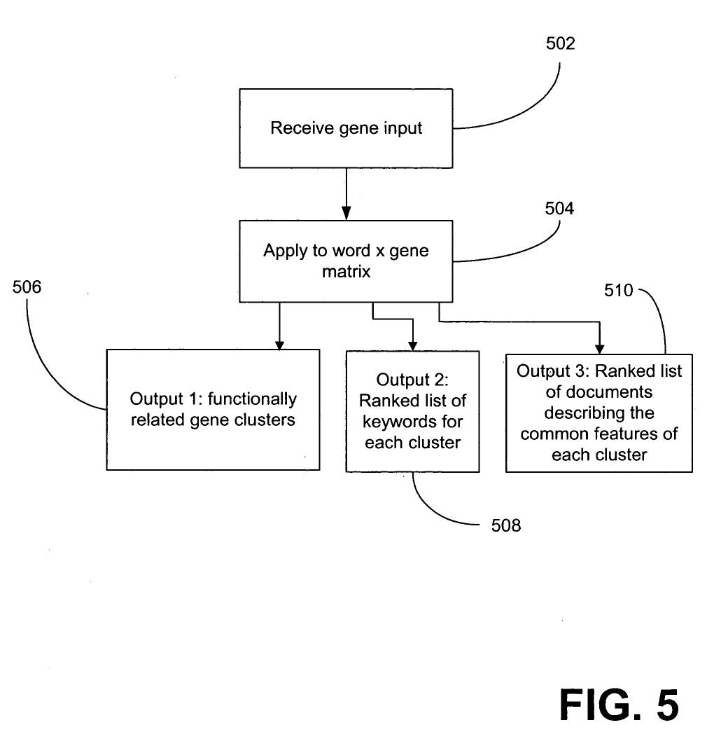

FIGS. 4A and 4B are flow diagrams depicting an example cluster method of the function cluster system 120 (FIG. 3), in accordance with one embodiment. The flow chart of FIGS. 4A-4B (and FIG. 5 described below) shows the architecture, functionality, and operation of a possible implementation of the function cluster system for gene inputs, with the understanding that protein inputs similarly apply. The method described in FIGS. 4A-4B provides for an “on-the-fly”type method for clustering genes, wherein pre-processing and processing for the function cluster system are run in real-time, in accordance with the preferred embodiments. FIG. 5 will be used to describe a method of the same outcome as the method described in FIGS. 4A-4B, although with an updateable gene x word matrix already established, thus eliminating some of the real-time pre-processing and processing steps of the method described in FIGS. 4A-4B. In this regard, each block represents a module, segment, or portion of code, which comprises one or more executable instructions for implementing the specified logical function(s). It should also be noted that in some alternative implementations, the functions noted in the blocks may occur out of the order noted in FIGS. 4A-4B (and FIG. 5). For example, two blocks shown in succession in FIGS. 4A-4B may in fact be executed substantially concurrently or the blocks may sometimes be executed in the reverse order, depending upon the functionality involved, as will be further clarified herein below.

In general, one or more gene and/or proteins (herein, further reference will be in the context of genes) are input into the function cluster system 120 (FIG. 3), and a search of abstracts in a literature database is made for the inputted gene. The frequency of words for each returned abstract for each gene is calculated and compared with a control group of words, and in one embodiment, a z-score for each gene/word pair is calculated. Then, genes that are associated with a large number of keywords, each with high z-scores, are clustered together, along with their corresponding keywords which infer functionality. Specifically, step 402 includes receiving one or more gene names as input, such as from a microarray database 140 (FIG. 1). Step 404 includes finding alias names of the inputted gene name. One challenge in implementing keyword search strategies is overcoming inconsistent naming conventions, especially since multiple synonyms are in wide use for many genes and proteins. The alias of a particular gene can be input by the user and/or an automated search can be performed that utilizes a gene thesaurus resident locally or accessed over a network. The gene thesaurus is preferably in the form of a thesaurus database, implemented using a look-up-table (LUT) integrated in software for the function cluster system 120 (FIG. 3) or otherwise accessible by the function cluster system 120. In other embodiments, a commonly used gene thesaurus such as those found in databases LocusLink and GeneCards can be accessed (e.g., over a network or stored internally to the function cluster system 120) as a separate or integral function of the function cluster system 120.

Step 406 includes querying (e.g., SQL query) a literature database for all references to the input gene name and its aliases. In one embodiment, the title and/or the abstract fields are queried, although in other embodiments full text searches in lieu of or in addition to the title and/or abstract searches can be implemented.

Step 408 includes selecting a method for a background set. A background set, as understood by one having ordinary skill in the art, is a control or reference set of words that is developed and used, in one embodiment, during a function cluster system pre-processing stage to statistically compare the frequency of a keyword in a query set (as explained below) with its average frequency in the background set. One or more of several selectable (e.g., user selectable) background sets of words with their corresponding frequencies of occurrence can be implemented. For example, statistical methods based in part on an extension of the work of Andrade and Valencia (1998) can be used to extract keywords from citations of the literature database, such as selecting abstracts associated with proteins in a remote, publicly accessible PDB Select database, which is a non-homologous subset of the HSSP (Homology-Derived Secondary Structure of Proteins) families of proteins. The following statistics are calculated for each word in the background set of words. The relative frequency of word “a” in family “i” (Fai, which ranges between 0 and 1) is calculated as Fai=Wai/Si, where Wai is the number of proteins in family “i” for which word “a” appears in at least one associated abstract of the literature database, and Si is the number of proteins in family “i”. The mean frequency of word “a” in the background set, and its standard deviation, is then calculated. These statistics form a baseline against which the frequency of a word in a query set can be compared.

As another example, Andrade and Valencia (1998) used a 1994 version of PDB Select to screen out homologous families, and used only those families with more than 5 proteins, which resulted in 71 protein families. There are currently 1155 homologous protein families, 790 of which have five or more members. In one embodiment, background sets are calculated using both 1155 and 790 protein families of PDB select. A further example of developing a background set includes calculating a background set of keywords from 50,000 randomly-selected abstracts (i.e., 1000 random sets, each including 50 abstracts), or 5 million abstracts divided randomly into 100,000 sets of 50 abstracts each. Thus, one or more of these (or other) methods (e.g., 1155 PDB Select families, 790 PDB Select families with greater than 4 entries, and random families), alone or in combination, can be used to generate a background set for comparison with the query set. Alternate background sets can be derived from groups of abstracts selected 1) at random from the entire set of the abstracts of one or more literature databases, grouped into sets, 2) the subset of abstracts from a particular literature database that contains a gene name, 3) using a functional definition of gene/protein families instead of the homology-based families of HSSP, 4) by journal source, 5) the top 100 journals rated by citation impact, and/or 6) according to year published, among others.

A list of abstracts is returned from the literature database (step 410), and the background set and query set are generated for the returned abstracts (steps 412 and 414). Functionally-relevant words culled from the literature database abstracts are assigned to each gene name based on having a statistically higher word frequency in that gene's abstracts compared to a background set of abstracts. Simple keyword searches rely on a syntactic scheme of exact matches (i.e., they have no knowledge of or understanding of the meaning of the word or its linguistic role). An approach based on natural language processing, on the other hand, analyzes words as parts of natural language, tagging them as parts of speech (noun, verb, adjective, etc). Using rules of grammar, the document is analyzed for what it represents. Because of ambiguities and difficulties of analyzing written natural language, a full linguistic analysis is typically computationally intensive. The use of ontologies (organized collections of related terms or concepts) assists in standardizing biological information. In the preferred embodiments, one or more of these keyword search strategies (e.g., statistical, syntactic, natural, etc.), alone or in combination, are used to derive a list of keywords.

A stemming algorithm of the clustering system 120 (FIG. 3) is implemented by the clustering system 120 to truncate multiple forms of a word (e.g., plurals) to their “core word” (step 416). One of a plurality of stemming rules can be selectively implemented, including ranges from weak (e.g., Andrade) to strong (e.g., Porter); or stemming may not be used at all in some implementations.

Step 418 includes filtering out words via a stop list. The stop list preferably removes commonly-used words from the abstracts. A variety of stop lists can be employed, integral to the function cluster system 120 (FIG. 3) and/or accessible via a network connection, such as an on-line pocket dictionary, among others. In a preferred embodiment, an on-line pocket-dictionary is modified to make the words more functionally and biologically significant, such as by removing non-biological connotations and statistically significant (as related to genes) words that have no functional implications.

Continuing at point “A” in FIG. 4B, step 420 includes calculating the word frequency in the query and background set. Step 422 includes calculating the z-score for each gene-word pair. In one embodiment, the function cluster system 120 (FIG. 3) generates a gene x keyword matrix, wherein each row corresponds to the inputted genes and each column corresponds to every keyword from the returned abstracts. The cells of each gene-word pair include the z-score. As understood by one having ordinary skill in the art, the z-score is a statistically derived number that indicates, in this case, the strength of association between the gene-word pair. The z-score typically includes a range of −2 to 100, with the higher number corresponding to a stronger gene-word pair association. A threshold z-score can be selectable, or fixed in some embodiments. A formula for calculating z-score of each word-gene pair is: z-score=(frequency of word use in query set—frequency of word use in background set)/(standard deviation of word frequency in background set).

An optimum combination of keyword selection parameters (z-score threshold for word acceptance, background sets, word stop list, and stemming algorithm) can be determined by precision-recall analysis. For example, the accuracy of the keyword-selection algorithms of the function cluster system 120 (FIG. 3) can be evaluated by comparing their output with the set of keywords selected by human investigators from an identical set of abstracts. A PERL script was developed that measures the number of true positives (tp; words in the algorithm-derived list also found in the investigator-derived list), the number of false positives (fp; words in the algorithm-derived list not found in the investigator-derived list), and the number of false negatives (fn; words in the investigator-derived list not found in the algorithm-derived list). Two metrics that can be used for evaluating an information retrieval scheme are recall (fraction of all relevant items that are retrieved) and precision (fraction of retrieved items that are relevant). When using precision-recall metrics to evaluate a keyword search algorithm, for example, each item would be a retrieved keyword. Normally, if recall improves, precision declines and vice versa. The script described above can be used to calculate the precision (P; the fraction of retrieved keywords that were also listed by investigators) and recall (R; the fraction of investigator-derived keywords that were retrieved) for the results from the algorithm under various parameters as follows:

P=tp/(tp+fp) (Eq. 1)

R=tp/(tp+fn) (Eq. 2)

The goal of this evaluation is to identify the background set, z-score and other modifications that optimize the performance of the keyword selection algorithms of the function cluster system 120 (FIG. 1). Typically as word selection becomes more stringent (increasing z-scores), P increases at the expense of R. The optimum combination of these parameters plus the z-score threshold can be estimated in one embodiment by minimizing the function,

v*(1−P)+(1−R), (Eq. 3)

where v is a positive integer. If v>1, the cost of false positives is weighted more heavily than the cost of false negatives, which is favored since it is desired to have as few irrelevant words as possible when classifying gene function. For example, in one experimental implementation, the best overall performance was achieved with the random background set, Porter strong stemming, the PD+ stop list and a z-score threshold for accepting the word in the analysis of ˜6. Note that other combinations may be optimal.

Step 424 includes applying a clustering algorithm to the gene x word matrix having the z-scores at each gene-word pair cell. This matrix is converted to a gene x gene matrix with the cells containing the sum of products of z-scores for shared keywords. Larger values for the sum of products of z-scores reflect stronger and more extensive keyword associations between gene-gene pairs. Several clustering algorithms can be used to generate gene clusters. In one embodiment the gene x gene matrix is sorted and partitioned by a bond energy algorithm used for allocation of attributes to files, with modifications to provide a heuristic to determine the “breakpoints” on the diagonal of the matrix that represent the strength of keyword sharing among genes. The clustering algorithm can be better understood if viewed as occurring in two stages. In a first stage, columns (and rows) are ordered to minimize the sum of the quotients of adjacent cells, where the larger value is divided by the smaller one. Reordering continues until there is no scope for further reordering. Then in stage 2, the matrix is partitioned by finding the “best” place to partition along the diagonal as the one where the two adjacent columns maximize the sum of the quotients of adjacent cells, where the quotient is computed as (higher value/lower value) for each pair of adjacent cells from two adjacent columns. Zeros in the denominator are replaced by ones. This process is iterated until clusters are created with a specified degree of granularity. Typically the number of clusters generated will be 10-30% of the number of genes inputted into the system. Genes that are positioned at the border of the two clusters (and not in the middle of either one) indicate, among other things, that these genes may have substantial interactions with both clusters.

In some embodiments, multiple clusters can be determined in one pass, and/or overlapping clusters can be determined. Note that in other embodiments, other heuristics and clustering methods well known to those having ordinary skill in the art can be used without departing from the spirit and scope of the invention.

Steps 426-430 include providing an output that comprises genes clustered according to functional groups (step 426), a ranked list of keywords for each cluster (step 428), and a ranked list of documents (step 430) for each cluster. Note that in other embodiments, the keywords and/or documents need not be ranked. The highest ranking keywords (e.g., those that are most informative of the common functions of genes in each cluster) can further be delineated in some embodiments. For example, a metric can be used to rank keywords according to their highest shared z-scores in each cluster. For example, one metric that can be used includes taking the sum of z-scores for a shared keyword multiplied by the number of genes within the cluster with which the word is associated. In this calculation, z-scores less than a user-selected threshold are set to zero. Thus, larger values reflect stronger and more extensive keyword associations within a cluster. Similarly, documents (e.g., the original abstracts used to extract keywords) reflecting common features of the clustered items can be ranked by the number of high scoring keywords contained in the document. These documents allow a user to evaluate the keywords in context.

FIG. 5 is a flow diagram depicting another example cluster method, in accordance with one embodiment of the invention. As indicated above, the results of implementing the method described in FIGS. 4A-4B can be compiled to create a new annotation database stored locally (e.g., local server, local computer storage such as on a DVD, etc.) that includes functionally-relevant keywords extracted automatically from current biomedical literature for every named gene in one or more literature databases, and the z-scores that characterize the strength of an association between each word-gene pair. This raw database (gene x word sparse matrix, with z-scores in the cells) is updated at regular intervals as the one or more source or central literature databases are updated, so that the keyword selection is up-to-date and is based on current literature. These informatics tools are preferably accessible via the Internet, and allow researchers to identify potential functional relationships more rapidly among a set of genes pulled out of a microarray study, and should facilitate the formation of hypotheses based on microarray results. Accordingly, as shown in FIG. 5, step 502 includes receiving a gene input. The gene input is applied to the raw word x gene matrix (step 504), and an output is produced in steps 506-510 as explained in association with FIGS. 4A-4B.

It will be understood that methods other than the z-score method can be implemented in some embodiments. Preferably, the method chosen will provide a numerical value calculated for each word analyzed. For example, one method that can be used is TFIDF (Term Frequency-Inverse Document Frequency). This approach is based on the standard TFIDF function (cƒ., Salton and Buckley, 1988, Information Processing and Management, 24:513-523). TFIDF combines Term Frequency (TF), which measures the number of times a word occurs in the gene; and Inverse Document Frequency (IDF), which measures the informativeness of a word: its rarity across all the families (or pseudo-families) in the background set, and it is calculated as:

$${idf}^{ a} = log \frac{N}{{df}^{ a}} \qquad ( 4 )$$

where idƒ^{a} denotes the inverse document frequency of word a in the background set; dƒ^{a} denotes the number of families (or pseudo-families) in which word a occurs; and N is the total number of families or pseudo-families in the background set.

And tfidf is defined as:

tƒidƒ_{g}^{a}=tƒ_{g}^{a}×idƒ^{a} (5)

tƒidƒ_{g}^{a} denotes the weight of the word a to the gene g; tƒ_{g}^{a} the number of times word a occurs in gene g.

For word weights to fall in a [0,1] interval, the weights resulting from TFIDF are often normalized by cosine normalization, given by

$${weight}_{g}^{ a} = \frac{{tfidf}_{g}^{ a}}{\sqrt{{\sum }_{s = 1}^{\vert W \vert} {( {tfidf}_{g}^{ s} )}^{2}}} \qquad ( 6 )$$

Where |W| denotes the number of words in gene g.

Similarly, z-scores can be normalized (normalized z-score method) as:

$${weight}_{g}^{ a} = \frac{{Z}_{g}^{ a}}{\sqrt{{\sum }_{s = 1}^{\vert W \vert} {( {Z}_{g}^{ s} )}^{2}}} \qquad ( 7 )$$

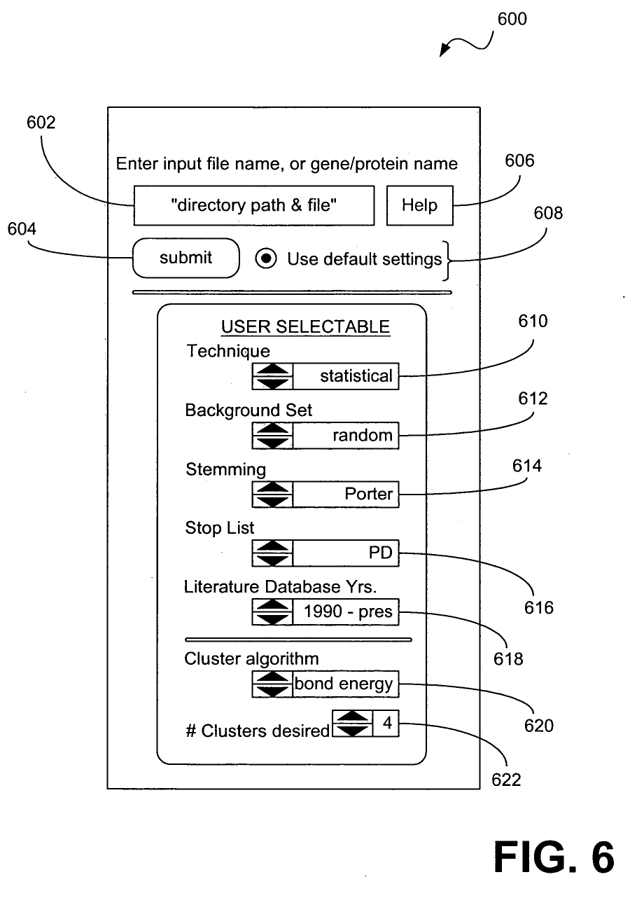

FIG. 6 is a schematic diagram depicting an example user interface 600, in accordance with one embodiment. The example user interface 600 shown is but one example among many for providing a user with an interface to the function cluster system 120 (FIG. 3), and can be generated and presented on a display screen at a local computer terminal or via a web page provided from a local or remote server, among other options. As shown, the example user interface 600 includes a file name entry window 602 corresponding to the location of the microarray database that the user can enter. The user can also enter the actual gene name and/or aliases. Upon entering the desired microarray data or gene/protein name, the user (e.g., via a mouse or other input mechanisms) selects the submit button icon 604 to begin the search among one or more literature databases for the desired genes and/or proteins. A “Help” button icon 606 is included to guide the user through the use of the user interface 600. The user can also choose to select the default settings 608 to avoid re-entry of the user selectable settings described below for the user interface 600. In the user selectable section of the user interface 600, the user is presented with scrollable setting options that include a keyword search technique window 610, background set window 612, stemming algorithm window 614, stop list window 616, literature database year window 618, cluster algorithm window 620, and the number of clusters window 622. Note that other scrollable setting options can be implemented, such as a literature database selection window that enables a user to select from a plurality of literature databases, among other possible settings. The keyword search technique window 610 enables a user to scroll through the various keyword search techniques, such as statistical, natural language, among others. Similarly, the background set window 612 provides the user with scrollable options that include random sets, 1155 PDB Select families, 790 PDB Select families with greater than 4 entries, etc. Like functionality applies to the stemming algorithm window 614, stop list window 616, literature database year window 618, cluster algorithm window 620, and the number of clusters window 622.

As an example implementation, assume the following gene/protein inputs and corresponding aliases:

Actin
Alpha-Spectrin: erythrocytic 1; elliptocytosis 2; EL2; SPTA1
Alpha-Tubulin
Beta-tubulin: Tubb1; M(beta)1
Catechol-O-methyltransferase: COMT
chorismate mutase
DOPA decarboxylase: DDC, AADC, aromatic amino acid decarboxylase;
Dopamine beta-hydroxylase: DBH; Dopamine beta-monooxygenase
Dynein: DNCH1; DNECL; DNCL; CDC23; DNCHC1; HL-3; DHC1;
P22; KIAA0325; CDC23
GluR1: GluR-1; GluRA; GluR-A; Gria1; AMPA1
GluR2: GluR-2 GluRB; GluR-B Gria2 AMPA2
GluR3: GluR-3 GluRC; GluR-C Gria3 AMPA3
GluR4: GluR-4 GluRD; GluR-D Gria4 AMPA4
GluR6: Grik2
KA1: Grik4
KA2: Grik5
Monoamine oxidase A: MAO-A
Monoamine oxidase B: MAO-B
NMDA-R1: NMDAR1; NR1; Grin1
NMDA-R2A: NMDAR2A; NR2A; Grin2A
NMDA-R2B: NMDAR2B; NR2B; Grin2B
Phenethanolamine N-methyltransferase: PNMT
prephenate dehydratase
prephenate dehydrogenase
Tyrosine hydroxylase: TH; Tyrosine 3-monooxygenase
tyrosine transaminase: tyrosine aminotransferase

The above gene/protein names and aliases are input into the function cluster system 120 (FIG. 3), and the following output is provided (though not limited to the particular format shown):

CLUSTER 1

CLUSTER 1

| | Keywords suggestive of a common function of the |
|---|---|
| Protein | proteins |
| Actin | Tubulin, dynein, spectrin, microtubule, axoneme, |
| Alpha-Tubulin | chlamydomona, Demembran, flagella, cytoskeleton, |
| Beta-tubulin | isotype, Protofila, tetrahymena, depolymer, subunit, |
| Dynein; | isoform, cilia, polymer, sequence, mutant, tyrosin, |
| | diverg, kinesin, pvuii, intron, codon, multigene, encod, |
| | cytoplasm, physarum |

CLUSTER 2

CLUSTER 2

| | Keywords suggestive of a common |
|---|---|
| Protein | function of the proteins |
| Tyrosine hydroxylase | Catechol, dopamine, oxidase, chromaffin |
| DOPA decarboxylase | selegiline, Dihydroxyphenyl, |
| Dopamine beta-hydroxylase | catecholamine, tyrosine, phenylethylamine |
| Phenethanolamine | adrenomedullari, dopa, tyramine, Medulla, |
| N-methyltransferase | pargyline, inhibitor, homovanill, |
| Monoamine oxidase A | catecholaminerg, Adren, enzyme, |
| Monoamine oxidase B | dihydroxyphenylalanine, coeruleu, |
| Catechol-O-methyltransferase | Parkinson, |
| tyrosine transaminase | moclobemide, noradrenerg, mptp, neuron |

CLUSTER 3

CLUSTER 3

| | |
|---|---|
| | Keywords suggestive of a common function |
| Protein | of the proteins |
| chorismate mutase | Herbicola, fluorophenylalanine, tryptophan, |
| prephenate | erwinia Catalyt, brevibacterium, substrate, enzyme, |
| dehydratase | dehydrogenase |
| prephenate | Decarboxyl, biosynthet, flavum, aromat, hel, subtili |
| dehydrogenase | Ammonium, sulfate, monom, molecular, arg, mutant |
| | Nicotinamide, subunit, tyr, effector, inhibitor |

CLUSTER 4

CLUSTER 4

| | |
|---|---|
| | Keywords suggestive of a common function of the |
| Protein | proteins |
| GluR1 | Ampa, ionotrop, kainate, glutam, isoxazole, subunit |
| GluR2 | Glutamaterg, homomer, receptor, methyl, propion, |
| GluR3 | hydroxi, |
| GluR4 | Neuron, domoate, hippocampu, gyru, synapt, |
| GluR6 | Methylisoxazole, hek, aspart, postsynapt, cerebellum, |
| KA1 | cortex, Isoxazolepropion, cyclothiazide, ca, heteromer, |
| KA2 | bergmann, Coloc, forebrain, purkinje, cerebellar |
| NMDA-R1 | |
| NMDA-R2A | |
| NMDA-R2B | |

The functions of the above indicated gene clusters can be inferred by knowledgeable investigators from keywords alone.

Note that in other embodiments, the strategy of linking text to functional entities can be extended to other fields in whole or in part, if the background sets of words are adjusted appropriately. For example, rather than link keywords to genes, modified algorithms could link adverse effects to drugs, or keywords to diseases. There are also situations in which it may be useful to reverse the “direction” of function cluster system operations. For example, if the user typed in the word “schizophrenia” or “diabetes” or “neurodegeneration”, the program could search the keyword lists for all gene names and generate a list of all genes with which the keyword is associated, returning strength of each gene-keyword association in the form of a z-score. Such lists of gene names will give the user a more comprehensive view of the genes involved in their keyword of interest and would be valuable in designing the layout of custom microarrays, especially since current microarrays contain only a fraction of well-known genes and the list of known genes is expanding rapidly.

The scope of the preferred embodiments can be extended by incorporating domain-specific knowledge in the form of ontologies, conceptual graphs and semantic networks, as discussed previously. These approaches incorporate existing knowledge in the form of known relationships (e.g., kinase and phosphatase, agonist and antagonist), which can further improve analyses and the clustering process.

It should be emphasized that the above-described embodiments, particularly any “preferred embodiments”, are merely possible examples, among others, of the implementations, setting forth a clear understanding of the principles of this disclosure. Many variations and modifications may be made to the above-described embodiments without departing substantially from the principles of this disclosure. All such modifications and variations are intended to be included herein within the scope of the disclosure and protected by the following claims.

What is claimed:

1. A method for organizing and aiding the interpretation of gene data, said method comprising the steps of:
receiving gene names;
associating the gene names to gene-word pair relationships; and
grouping the gene names with high strength of gene-word relationships, the strength of the gene-word relationships corresponding to the relatedness in function of corresponding grouped genes.

2. The method of claim 1, wherein the receiving gene names includes receiving alias names for the gene names.

3. The method of claim 1, further including querying the gene names in a literature database.

4. The method of claim 3, wherein the receiving includes, responsive to the query of the gene names in a literature database, receiving abstracts comprising the gene names.

5. The method of claim 4, further including generating a background set and a query set from the returned abstracts.

6. The method of claim 5, further including calculating word frequencies in the query set and the background set.

7. The method of claim 6, further including providing a numerical value calculated for each word in which a word frequency was calculated for the query set.

8. The method of claim 7, wherein the providing includes calculating z scores.

9. The method of claim 7, wherein the providing includes using term frequency-inverse document frequency methods.

10. The method of claim 4, further including stemming words of the returned abstracts.

11. The method of claim 10, further including filtering the stemmed words using a stop list.

12. A system for organizing and aiding the interpretation of data, said system comprising:
a memory with logic; and
a processor configured with the logic to receiving gene names, said processor further configured with the logic to associate the gene names to gene-word pair relationships, said processor further configured with the logic to group the gene names with high strength of gene-word relationships, the strength of the gene-word relationships corresponding to the relatedness in function of corresponding grouped genes.

13. The system of claim 12, wherein the processor is further configured with the logic to generate keywords that describe the common function of each group.

14. A system for organizing and aiding the interpretation of gene data, said system comprising:
means for receiving gene names;
means for associating the gene names to gene-word pair relationships; and means for grouping the gene names with a similar strength of gene-word relationships, the strength of the gene-word relationships corresponding to the relatedness in function of corresponding grouped genes.
